(19) United States
(12) Patent Application Publication
(10) Pub. No.: US 2017/0341044 A1
(43) Pub. Date: Nov. 30, 2017

(54) Carbon Dioxide Regulating System for Home Beer Brewing

(71) Applicant: Northern Brewer LLC, Roseville, MN (US)

(72) Inventors: Cord-Friedrich Koening, Minneapolis, MN (US); Joshua Voeltz, Minneapolis, MN (US); Bradley W. Segall, Minneapolis, MN (US)

(73) Assignee: Northern Brewer LLC, Roseville, MN (US)

(21) Appl. No.: 15/604,292

(22) Filed: May 24, 2017

Related U.S. Application Data
(60) Provisional application No. 62/340,767, filed on May 24, 2016.

(51) Int. Cl. B01F 15/00; C12C 13/10; F16K 31/60; B01F 3/04; G01L 19/16; G01L 19/06

(52) U.S. Cl. CPC B01F 15/00357; G01L 19/16; G01L 19/06; F16K 31/60; B01F 3/04808; C12C 13/10; B01F 15/00162; B01F 2003/049

(57) ABSTRACT

A carbon dioxide regulator assembly for use in carbonating home brewed beer includes a first pressure gauge that includes a first gauge face. The first gauge face includes a first region having a first indicia indicating a carbonation pressure range of a first type of beer at a predefined temperature, a second region having a second indicia indicating a carbonation pressure range of a second type of beer at the predefined temperature, a third region having a third indicia indicating a carbonation pressure range of a third type of beer at the predefined temperature, and a fourth region having a fourth indicia indicating a carbonation pressure range of an over-carbonation condition at the predefined temperature. The first indicia, the second indicia, the third indicia, and the fourth indicia are each non-alpha-numeric.

### FIELD OF THE INVENTION

This disclosure relates generally to regulating systems and, more particularly, to carbon dioxide regulating systems for home beer brewing.

### BACKGROUND

U.S. Pat. No. 7,785,003 granted to Blichmann on Aug. 3, 2010 discloses a beer brewing temperature measurement device to aid in the brewing of beer. A special dial face is provided with common brewing process temperature ranges and ideal process target temperatures, guiding the brewer through the brewing process. The dial face as shown in FIG. 1 correlates temperatures with specific sections of the beer brewing process.

U.S. Patent Publication no. 2016/0059191 A1 published on Mar. 3, 2016 by Bandixen et al. discloses a water dispensing machine and a carbonated beverage dispensing system which facilitates a combination of carbon dioxide with water in a configuration which provides a smaller footprint and reduces or eliminates dependency on remotely located carbon dioxide tanks and flavoring systems. The system may be configured to produce only carbonated water or to allow the user to select carbonated water or chilled water, and, alternatively, ambient, un-chilled water. A carbonator of the system introduces carbon dioxide to a chilled water stream using an injector with slots. This inline, on demand carbonation system provides benefits over carbonator tank systems which carbonate large volumes of carbonated water in bulk.

U.S. Patent Publication no. 2013/0108760 A1 published on May 2, 2013 by Kumar et al. discloses an inline carbonation apparatus having a fluid tube with an inner diameter. A water flow control module is connected to a water source. At least one water orifice is linked to the water flow control module and is attached at one end of the fluid tube. The water orifice includes a plurality of holes atomizing water passing therethrough. A carbon dioxide source is connected to a carbon dioxide valve. The carbon dioxide solenoid valve is connected to a carbon dioxide regulator that is coupled to a carbon dioxide orifice and attached to the fluid tube in a spaced relationship from the water orifice. The atomized water has a pressure less than the carbon dioxide such that carbon dioxide is absorbed into the water forming carbonated water having a specified volume of carbonation. The water control module regulates a water flow rate into the inline carbonation apparatus.

Improvements are desired for metering the carbonation of beer in a home beer brewing system that will save time and minimize mistakes that could occur in the carbonation of beer.

### BRIEF SUMMARY OF THE DISCLOSURE

A carbon dioxide regulator assembly for use in carbonating home brewed beer includes an inlet adapted to be coupled to a carbon dioxide source and a first valve adapted to control flow of carbon dioxide from the inlet to a first outlet of the carbon dioxide regulator, the first outlet adapted to be in fluid communication with a first keg in which a first batch of beer to be carbonated is stored. The carbon dioxide regulator assembly includes a first pressure gauge adapted to be in fluid communication with carbon dioxide flowing through the first outlet when the first valve is in an open or partially-open position. The first pressure gauge includes a first gauge face having a first region having a first indicia indicating a carbonation pressure range of a first type of beer at a predefined temperature, a second region having a second indicia indicating a carbonation pressure range of a second type of beer at the predefined temperature, a third region having a third indicia indicating a carbonation pressure range of a third type of beer at the predefined temperature, and a fourth region having a fourth indicia indicating a carbonation pressure range of an over-carbonation condition at the predefined temperature, wherein the first indicia, the second indicia, the third indicia, and the fourth indicia are each non-alpha-numeric. The first pressure gauge also includes a first needle that rotatably displaces relative to the first gauge face based on pressure of the carbon dioxide flowing through the first outlet.

### BRIEF DESCRIPTION OF THE DRAWINGS

FIG. 1 is a front view of a CO₂ regulating system that includes a known CO₂ regulator assembly;

FIG. 2 is a typical chart that correlates temperatures and CO₂ pressures necessary to properly carbonate different varieties of beer;

FIG. 3 is a front view of a CO₂ regulating system that includes an embodiment of a CO₂ regulator assembly;

FIG. 4 is a front view of an embodiment of a first gauge face of a first pressure gauge of an embodiment of a CO₂ regulator assembly; and

FIG. 5 is a front view of an embodiment of a first gauge face of a first pressure gauge of an embodiment of a CO₂ regulator assembly.

### DETAILED DESCRIPTION

Conventional home beer brewing equipment typically includes: a kettle and an adjacent burner kit; chillers, a fermenter, carboy or other container; a bottling bucket, and cleaners, sanitizers, brushes and other cleaning equipment; tubing for siphoning and bottling; beer bottles, caps and a bottle capper; malted barley or extracts or other cereal grains; hops, yeast and other accessories and ingredients dependent on the specific beer recipe. A keg may also be used for carbonating and storing beer under pressure for dispensing.

The brewing process includes the steps of making wort by soaking grains in water to release malt sugars—alternatively previously made dry or liquid extract can be used, boiling the wort and water together with the hops and cooling the wort after boiling; and fermenting the cooled wort for a predetermined period of time in a primary fermentation process by adding yeast to the wort. A large bottle also known as a carboy is traditionally used in home brewing to produce beer from the wort due to the fermentation activities of yeast added to the wort within the carboy.

After the fermentation process is completed, the wort is transferred from the carboy for instance, to consumer drinking bottles or to a keg. When the beer has been transferred to a keg, it is necessary to carbonate the beer according to the specific variety of beer being produced. Different beers are supposed to be carbonated at different levels, for example, a stout beer needing very little carbonation while most Belgian beers are very highly carbonated. Different levels of carbonation are achieved by putting the keg under different levels of pressure which thus forces different amounts of carbon dioxide (CO₂) into solution within the beer in the keg. This common home beer brewing carbonation method is referred to as force carbonation. When force carbonating beer, one normally uses a CO₂ regulator to meter the amount of CO₂ being fed into the keg.

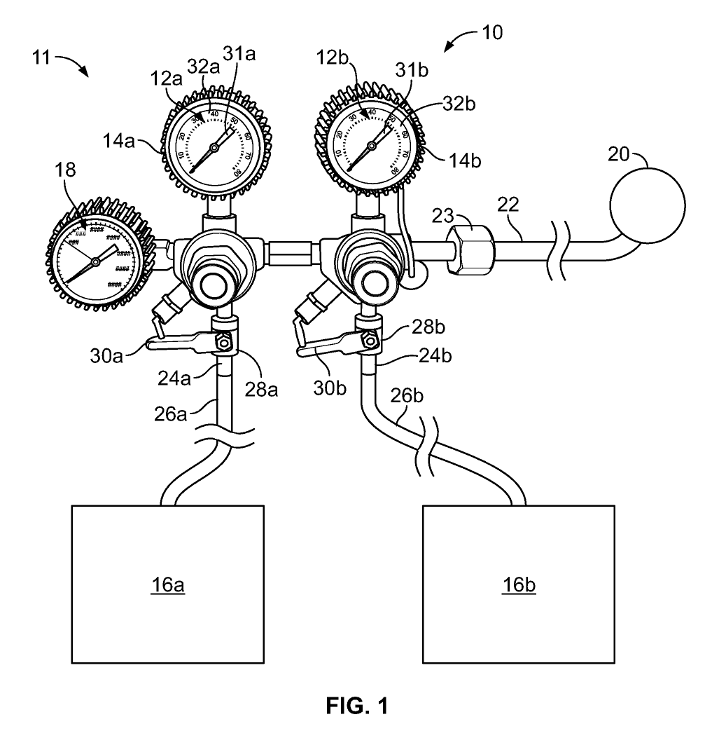

FIG. 1 illustrates an embodiment of a CO₂ regulating system 11 that includes a known CO₂ regulator assembly 10 which includes two dial faces 12a, 12b associated with two respective pressure gauges (e.g., a first pressure gauge 14a and a second pressure gauge 14b) for reading CO₂ pressure being forced into two separate kegs (e.g., a first keg 16a and second keg 16b). A source dial 18 indicates how much pressure (and therefore CO₂ gas) is available in a source tank 20 of CO₂.

The CO₂ travels from the source tank 20 through a source supply line 22 and into an inlet 23 of the CO₂ regulator 10 when the inlet 23 is coupled to the source tank 20. The CO₂ exits one of a first valve 28a or a second valve 28b to be received into a corresponding one (or both) of the first keg 16a and the second keg 16b. The first pressure gauge 14a and the second pressure gauge 14b of the conventional CO₂ regulator assembly 10 has a face that includes a numerical value of the CO₂ pressure going into the corresponding one of the first keg 16a or the second keg 16b. The CO₂ regulator 10 includes a first coupling 24a (or a first outlet 24a) for sending CO₂ to the first keg 16a via a first supply line 26a (e.g., a hose), and the first pressure gauge 14a measures the CO₂ pressure going into the first keg 16a. The regulator assembly 10 includes the first valve 28a having a first adjusting member 30a (e.g., a dial/knob/control or similar adjustment device) used for manually adjusting the pressure level of the CO₂ entering the first keg 16a. Put another way, the first valve 28a is adapted to control flow of CO₂ from the inlet 23 to the first outlet 24a, and the first outlet 24a is adapted to be in fluid communication with the first keg 16a. Thus, by displacing (e.g., rotating) the first adjusting member 30a, the first valve 28a may be fully-opened or partially opened to allow a desired amount of CO₂ from the source tank 20 into the first keg 16a. The first adjusting member 30a may also be displaced to close the first valve 28a to prevent CO₂ from the source tank 20 from entering into the first keg 16a. The first pressure gauge 14a is (or is adapted to be) in fluid communication with carbon dioxide flowing through the first outlet 24a (and/or the first valve 28a) when the first valve 28a is in the open (i.e., fully-open) or partially-open position.

The CO₂ regulator assembly 10 of the CO₂ regulating system 11 may also include a second coupling 24b (i.e., a second outlet 24b) for sending CO₂ to the second keg 16b via a second supply line 26b (e.g., a hose), and the second pressure gauge 14b measures the CO₂ pressure going into the second keg 16b. The regulator assembly 10 includes the second valve 28b having a second adjusting member 30b (e.g., a dial/knob/control or similar adjustment device) used for manually adjusting the pressure level of the CO₂ entering the second keg 16a. Put another way, the second valve 28b is adapted to control flow of CO₂ from the inlet 23 to the second outlet 24b, and the second outlet 24b is adapted to be in fluid communication with the second keg 16b. Thus, by displacing (e.g., rotating) the second adjusting member 30b, the second valve 28b may be fully-opened or partially opened to allow a desired amount of CO₂ from the source tank 20 into the second keg 16a. The second adjusting member 30b may also be displaced to close the second valve 28b to prevent CO₂ from the source tank 20 from entering into the second keg 16b. The second pressure gauge 14b is (or is adapted to be) in fluid communication with carbon dioxide flowing through the second outlet 24b (and/or the second valve 28b) when the second valve 28b is in the open (i.e., fully-open) or partially-open position.

One having ordinary skill in the art would recognize that the CO₂ regulator assembly 10 may have any number of additional pressure gauges (not shown) couplings (not shown), and valves (not shown) to provide CO₂ to any number of additional kegs. Similarly, the CO₂ regulator assembly 10 may have only a first pressure gauge 14a, a first coupling 24a, and a first valve 28a to provide CO₂ to only a first keg 16a.

If the first or second valve 28a, 28b is displaced to a first partially-opened position, then a relatively low pressure of CO₂ is supplied to a corresponding one of the first keg 16a or the second keg 16b. If the first or second valve 28a, 28b is further displaced to a second partially-opened position, then the pressure of the CO₂ in the corresponding one of the first keg 16a or the second keg 16b will rise proportionately. The first or second adjusting member 30a, 30b can be displaced to the closed position to completely close the first or second valve 28a, 28b whereby no CO₂ will be sent to the first or second keg 16a, 16b. At the other extreme, the first or second adjusting member 30a, 30b can be displaced to the fully-opened position to provide maximum CO₂ pressure from the CO₂ source tank 20.

The pressure level within each of the first and second keg 16a, 16b can also be characterized as a volume of CO₂ which is known to be a dimensionless quantity, whereby the volume of CO₂ in the keg is defined as liters of CO₂ dissolved in one liter of beer at 1 atm at 20 degrees Celsius, where 1 atm is the standard atmosphere unit of pressure defined as 1.01325 bar.

The pressure level in each of the first keg 16a and the second keg 16a is determined by a user by observing a rotational position of a first or second needle 31a, 31b that moves or displaces relative to a fixed first gauge face 32a and second gauge face 32b, respectively. The first gauge face 32a and the second gauge face 32b may be identical and may have a plurality of hash marks that may be labeled by a number that indicates a corresponding pressure. Thus, as would be understood by one having ordinary skill in the art, the first needle 31a of the first pressure gauge 14a of FIG. 1 is in a position labeled 0 psi of the first gauge face 32a, indicating that the CO₂ pressure into the first keg 16a is 0 psi. Similarly, the second needle 31b of the second pressure gauge 14b is in a position labeled 0 psi of the second gauge face 32b, indicating that the CO₂ pressure into the second keg 16a is 0 psi.

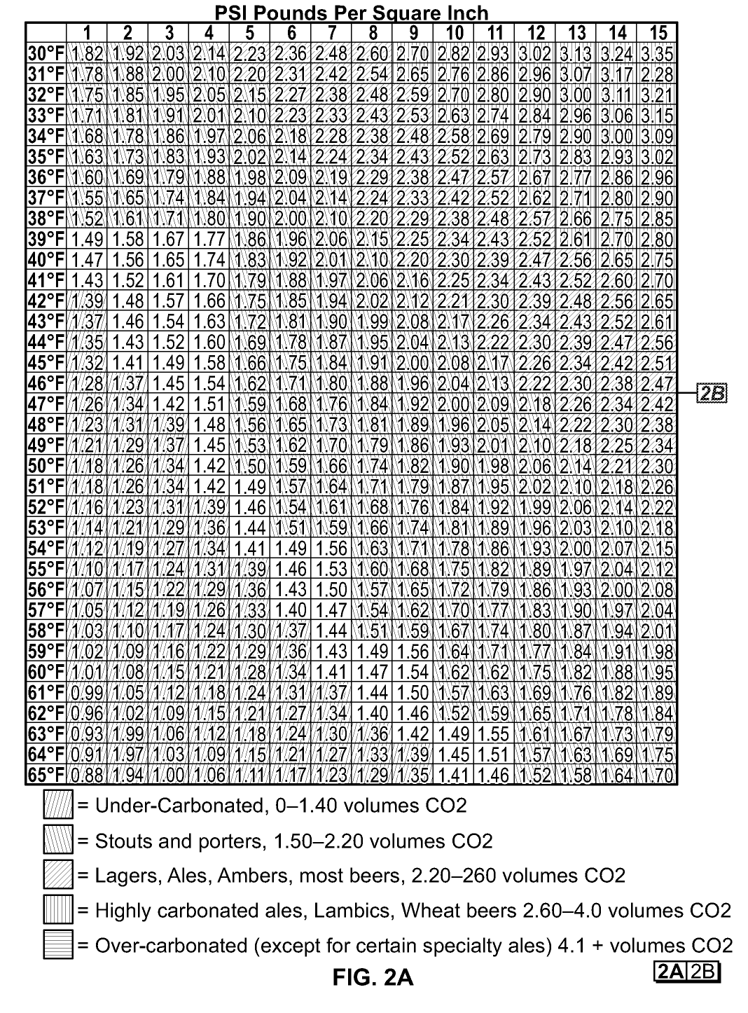

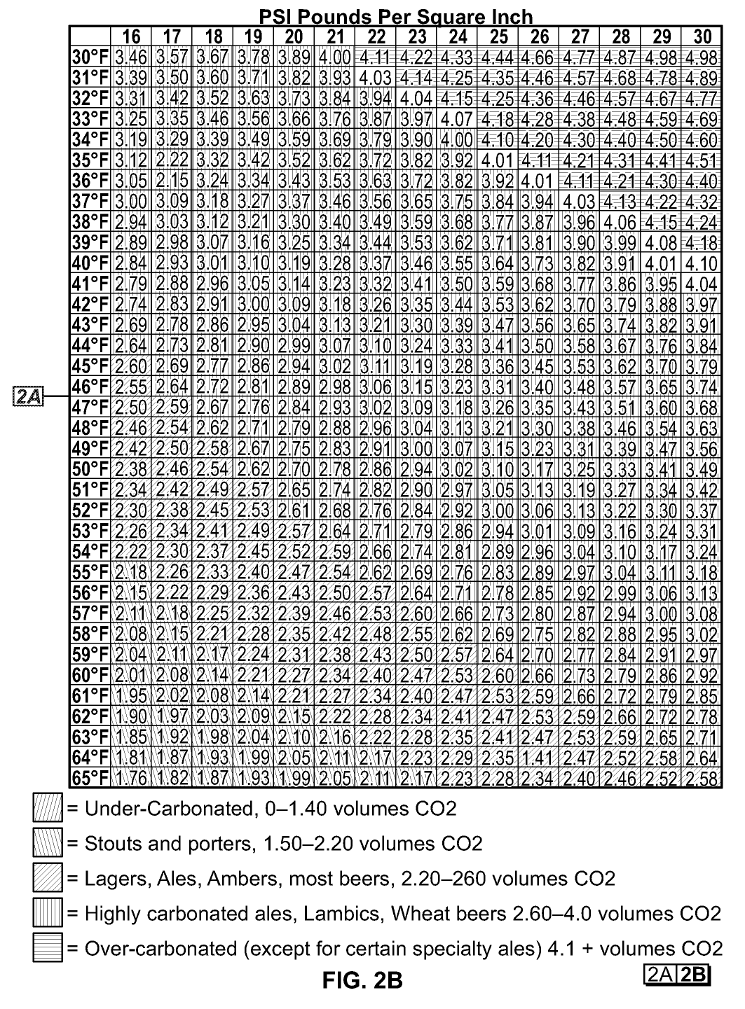

In order to determine the proper or optimum CO₂ pressure or volume for insertion into a keg (such as the first or second keg 16a, 16b) when carbonating beer, a home beer brewer is typically provided with a chart similar to that illustrated in FIG. 2. The chart of FIG. 2 correlates temperatures and CO₂ pressures that are necessary to properly carbonate different varieties of beer such as, but not limited to stouts, porter, lagers, ales, ambers, highly carbonated ales, and Iambics. Of course, all other beers could fall onto this or a similar temperature/pressure/CO₂ volume chart. The chart of FIG. 2 essentially provides that given a specific temperature, a specific amount of pressure in the system will force a specific amount of CO₂ (measured in volumes of CO₂) into solution. The temperature may be measured by any method or device known in the art. The pressure would be determined by looking at the corresponding one of the first needle 31a relative to the first gauge face 32a of the first pressure gauge 14a or the second needle 31b relative to the second gauge face 32b of the second pressure gauge 14b.

Consulting such a chart is tedious and can be difficult to interpret, even for trained home beer brewers. Mistakes in reading or interpreting the chart can sometimes lead to a consumer of a home beer brewing system making a faulty determination which can result in improper carbonation of a particular desired beer. Moreover, reading the exact position of the first or second needle 31a, 31b relative to the first or second gauge face 32a, 32b of the first or second pressure gauge 14a, 14b may be difficult for the user.

The current invention is a marked improvement over previously known systems and methods, including the above-described regulator assembly 10 and chart, for force carbonation of beer in a home beer brewing environment.

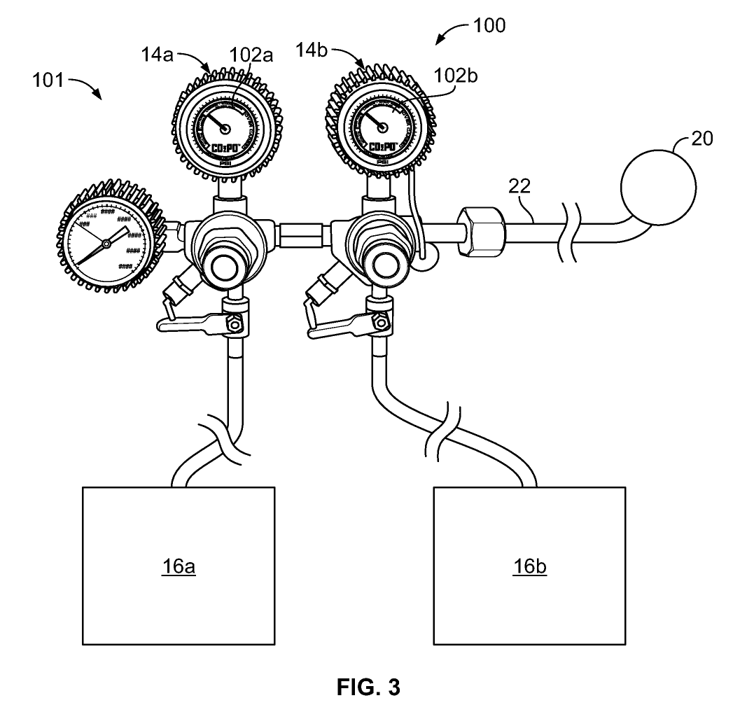

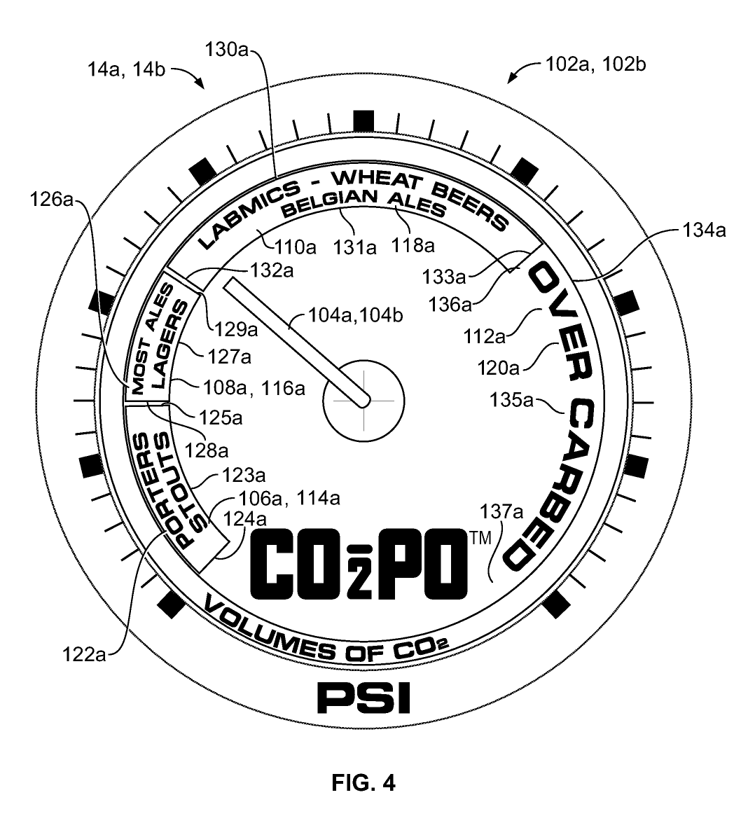

More particularly, and with reference to FIG. 3, an embodiment of a CO₂ regulating system 101 may include an embodiment a CO₂ regulator assembly 100 of the current invention that is mostly identical to the previously-described CO₂ regulator assembly 10, and like components will have identical reference numbers. However, the first pressure gauge 14a and the second pressure gauge 14b of the CO₂ regulator 100 do not have the same first or second gauge face 32a, 32b illustrated in FIG. 1. Instead, each of the first pressure gauge 14a and the second pressure gauge 14b of the CO₂ regulator assembly 100 may have a first gauge face 102a or second gauge face 102b, and an embodiment of a first gauge face 102a is illustrated in FIG. 4. A second gauge face 102b may be identical to the first gauge face 102a. Such a first gauge face 102a allows simplification of the carbonation process.

Instead of requiring either (1) the determination from a chart or otherwise of a numerical CO₂ pressure value for a specific beer type at a given carbonation temperature, or (2) a CO₂ volume at a given pressure or temperature as taught by the prior art, the first gauge face 102a is configured such that a first needle 104a is set to fall within one of the predetermined regions or sections of beer varieties as shown on the first gauge face 102a when measuring the carbonation pressure of CO₂ being inserted into the first keg 16a. In one embodiment, the first gauge face 102a has two or more regions or sections labeled for particular types of beers. As illustrated in FIG. 4, the first gauge face 102a may have four regions: a first region 106a, a second region 108a, a third region 110a, and a fourth region 112a. Each of the first to fourth regions 106a-112a may correspond to a range of carbonation pressure (within a known range or value of temperature, such as a predefined temperature or temperature range). For example, the first region 106a may correspond to porters and stouts, the second region 108a may correspond to most ales and lagers, the third region 110a may correspond to Iambics, wheat beers, and Belgian ales, and the fourth region 112a may correspond to an over-carbonation condition (i.e., a condition in which an excessive amount of carbonation is present in the batch of beer). Other regions or sections could be included, or omitted, from the first gauge face 102a to provide regions associated with the carbonation of any particular beer type.

For example, in the embodiment of FIG. 4, the first needle 104a is pointing to a CO₂ pressure within the Iambics, wheat beers and Belgian ales range (i.e., the third region 110a) at an ideal carbonation temperature. Because the ideal carbonation temperature, i.e. the set temperature or predetermined or predefined temperature, for these various home brewed beers is 38 degrees Fahrenheit, the embodiment of the first gauge face 102a is for use with refrigeration systems set at that temperature. If desired, other embodiments of the first gauge face 102a could be supplied for different carbonation temperatures.

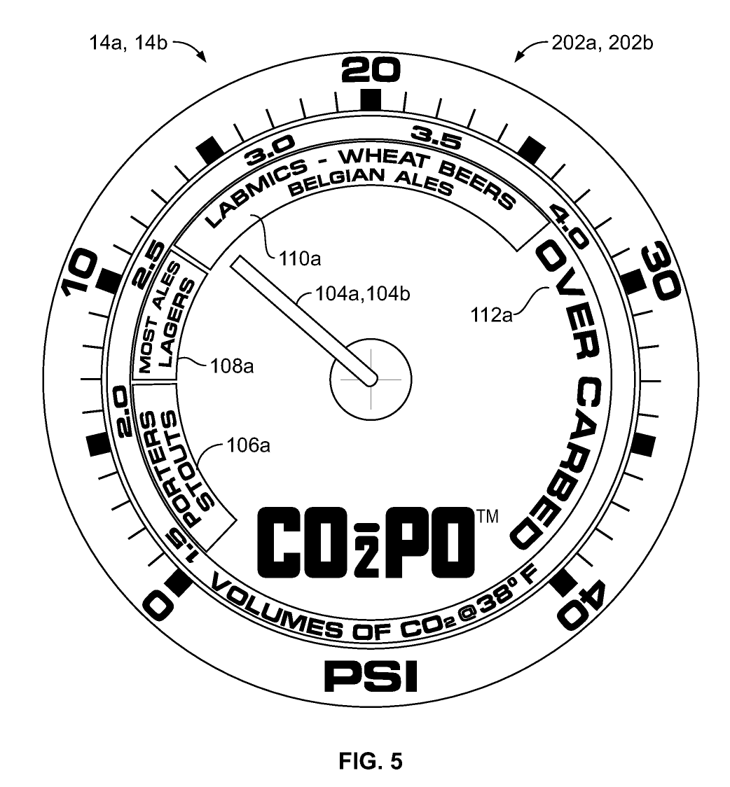

Moreover, other embodiments of the first gauge face 102a could optionally include additional information about the carbonation process such as (1) the volume of CO₂ at the set temperature, e.g., 38 degrees Fahrenheit, (2) the pounds per square inch PSI (or other units) of pressure of the CO₂ being put into the keg 16a, 16b from the CO₂ source tank 20, (3) the carbonation temperature (in this case, 38 degrees Fahrenheit), etc. For example, FIG. 5 illustrates an embodiment of an example first gauge face 202a that is similar to the first gauge face 102a discussed above but that includes inner dial values of volumes of CO₂ ranging from 1.5 to 4.0, and outer dial values of pounds per square inch (PSI) of pressure of the CO₂ being applied to the beer in the first keg 16a. Other embodiments of the first gauge face 102a could be used also with respect to providing an indication of a CO₂ level within the keg 16a, 16b.

In use, the home beer brewer would merely turn or adjust the first adjusting member 30a of the first valve 28a of the CO₂ regulator assembly 100 until the first needle 104a (i.e. gauge indicator) is within the desired region of the first gauge face 102a for the beer of choice. Thus, there is no need to interpret a complicated chart as shown above, or to otherwise determine the necessary settings for CO₂ pressure, temperature, or CO₂ volume for a particular beer style.

The first and second gauge face 102a, 102b regions (i.e., the first region 106a, 106b; the second region 108a, 108b; the third region 110a, 110b; and the fourth region 112a, 112b) or sections are each correlated with a different desirable pressure range suitable for carbonating a different predetermined variety of beer, and wherein changing the pressure level by adjusting the first or second adjusting member 30a, 30b will simultaneously move the corresponding first or second needle 104a, 104b along or relative to the corresponding first or second gauge face 102a, 102b to point to one of the different respective regions (i.e., the first region 106a, 106b; the second region 108a, 108b; the third region 110a, 110b; and the fourth region 112a, 112b) corresponding to the adjusted CO₂ pressure level, wherein the first or second gauge face 102a, 102b sections do not include numerical pressure values of the carbon dioxide input into the first or second kegs 16a, 16b. Instead of providing numerical values for the volumes of CO₂ and the pressure of the CO₂, e.g. psi, in the beer keg, the different regions or sections of the first and second gauge face 102a, 102b are delineated or defined, for instance, by different colored sections or regions, or different sections or regions marked by the desired beers, or different sections or regions indicated by other markings as desired. Also, there need be no indication of psi pressure or volumes of CO₂ on the first or second gauge face 102a, 102b at all, and the first or second gauge face 102a, 102b need not be labeled as measuring these values.

For example, in the embodiment of FIG. 4, the first region 106a of the first gauge face 102a may have, be indicated by, or be defined by a first indicia 114a indicating a carbonation pressure range of a first type of beer at a predefined temperature (e.g., 38 degrees Fahrenheit). The first indicia 114a (or the first region 106a) may include or comprise an area having or including any color (or combination of colors), shape (or combination of shapes), and/or pattern (or combination of patterns) or any other characteristic (or combination of characteristics) capable of visibly distinguishing the first indicia 114a (or the first region 106a) from any or all of the second indicia 116a (or the second region 108a), the third indicia 118a (or the third region 110a), and/or the fourth indicia 120a (or the fourth region 112a).

In some embodiments, the area or shape of the first indicia 114a (or the first region 106a) may have an arcuate shape (i.e., a shape or general shape of an arc or segment of a circle). For example, in the embodiment of FIG. 4, the area or shape of the first indicia 114a (or the first region 106a) may include or may be defined by a top segment portion 122a extending from a first end to a second end, a bottom segment portion 123a extending from a first end to a second end, a first lateral end portion 124a extending from the first end of the top segment portion 122a to the first end of the bottom segment portion 123a, and a second lateral end portion 125a extending from the second end of the top segment portion 122a to the second end of the bottom segment portion 123a. The top segment portion 122a and the bottom segment portion 123a may each be non-linear or curved. For example, the top and bottom segment portions 122a, 123a may each be circular segments having a same (or shared) center point, with the bottom segment portion 123a having a smaller radius than the top segment portion 122a.

As illustrated in FIG. 4, the second region 108a of the first gauge face 102a may have, be indicated by, or be defined by a second indicia 116a indicating a carbonation pressure range of a second type of beer at a predefined temperature (e.g., 38 degrees Fahrenheit). The second indicia 116a (or the second region 108a) may include or comprise an area having or including any color (or combination of colors), shape (or combination of shapes), and/or pattern (or combination of patterns) or any other characteristic (or combination of characteristics) capable of visibly distinguishing the second indicia 116a (or the second region 108a) from any or all of the first indicia 114a (or the first region 106a), the third indicia 118a (or the third region 110a), and/or the fourth indicia 120a (or the fourth region 112a).

In some embodiments, the area or shape of the second indicia 116a (or the second region 108a) may have an arcuate shape (i.e., a shape or general shape of an arc or segment of a circle). For example, in the embodiment of FIG. 4, the area or shape of the second indicia 116a (or the second region 108a) may include or may be defined by a top segment portion 126a extending from a first end to a second end, a bottom segment portion 127a extending from a first end to a second end, a first lateral end portion 128a extending from the first end of the top segment portion 126a to the first end of the bottom segment portion 127a, and a second lateral end portion 129a extending from the second end of the top segment portion 126a to the second end of the bottom segment portion 127a. The top and bottom segment portions 126a, 127a may each be non-linear or curved. For example, the top and bottom segment portions 126a, 127a may each be circular segments having a same (or shared) center point, with the bottom segment portion 127a having a smaller radius than the top segment portion 126a.

As illustrated in FIG. 4, the third region 110a of the first gauge face 102a may have, be indicated by, or be defined by a third indicia 118a indicating a carbonation pressure range of a third type of beer at a predefined temperature (e.g., 38 degrees Fahrenheit). The third indicia 118a (or the third region 110a) may include or comprise an area having or including any color (or combination of colors), shape (or combination of shapes), and/or pattern (or combination of patterns) or any other characteristic (or combination of characteristics) capable of visibly distinguishing the third indicia 118a (or the third region 110a) from any or all of the first indicia 114a (or the first region 106a), the second indicia 116a (or the second region 108a), and/or the fourth indicia 120a (or the fourth region 112a).

In some embodiments, the area or shape of the third indicia 118a (or the third region 110a) may have an arcuate shape (i.e., a shape or general shape of an arc or segment of a circle). For example, in the embodiment of FIG. 4, the area or shape of the third indicia 118a (or the third region 110a) may include or may be defined by a top segment portion 130a extending from a first end to a second end, a bottom segment portion 131a extending from a first end to a second end, a first lateral end portion 132a extending from the first end of the top segment portion 130a to the first end of the bottom segment portion 131a, and a second lateral end portion 133a extending from the second end of the top segment portion 130a to the second end of the bottom segment portion 131a. The the top and bottom segment portions 130a, 131a may each be non-linear or curved. For example, the top and bottom segment portions 130a, 131a may each be circular segments having a same (or shared) center point, with the bottom segment portion 131a having a smaller radius than the top segment portion 130a.

As illustrated in FIG. 4, the fourth region 112a of the first gauge face 102a may have, be indicated by, or be defined by a fourth indicia 120a indicating a carbonation pressure range of a fourth type of beer at a predefined temperature (e.g., 38 degrees Fahrenheit). The fourth indicia 120a (or the fourth region 112a) may include or comprise an area having or including any color (or combination of colors), shape (or combination of shapes), and/or pattern (or combination of patterns) or any other characteristic (or combination of characteristics) capable of visibly distinguishing the fourth indicia 120a (or the fourth region 112a) from any or all of the first indicia 114a (or the first region 106a), the second indicia 116a (or the second region 108a), and/or the third indicia 118a (or the third region 110a).

In some embodiments, the area or shape of the fourth indicia 120a (or the fourth region 112a) may have an arcuate shape (i.e., a shape or general shape of an arc or segment of a circle). For example, in the embodiment of FIG. 4, the area or shape of the fourth indicia 120a (or the fourth region 112a) may include or may be defined by a top segment portion 134a extending from a first end to a second end, a bottom segment portion 135a extending from a first end to a second end, a first lateral end portion 136a extending from the first end of the top segment portion 134a to the first end of the bottom segment portion 135a, and a second lateral end portion 137a extending from the second end of the top segment portion 134a to the second end of the bottom segment portion 135a. The the top and bottom segment portions 130a, 131a may each be non-linear or curved. For example, the top and bottom segment portions 134a, 135a may each be circular segments having a same (or shared) center point, with the bottom segment portion 135a having a smaller radius than the top segment portion 134a.

In some embodiments, the center point of the top segment portion 122a, 126a, 130a, 134a and the bottom segment portion 123a, 127a, 131a, 135a of each (or any two or more) of the first indicia 114a (or the first region 106a), the second indicia 116a (or the second region 108a), the third indicia 118a (or the third region 110a), and the fourth indicia 120a (or the fourth region 112a) are the same.

In some embodiments, the radius of the top segment portions 122a, 126a, 130a, 134a of each (or any two or more) of the first indicia 114a (or the first region 106a), the second indicia 116a (or the second region 108a), the third indicia 118a (or the third region 110a), and the fourth indicia 120a (or the fourth region 112a) may be the same or approximately the same. In addition, the radius of the bottom segment portions 123a, 127a, 131a, 135a of each (or any two or more) of the first indicia 114a (or the first region 106a), the second indicia 116a (or the second region 108a), the third indicia 118a (or the third region 110a), and the fourth indicia 120a (or the fourth region 112a) may be the same or approximately the same.

In some embodiments, the first indicia 114a (or the first region 106a) may have or be defined by an area having a first color (e.g., a tan color), the second indicia 116a (or the second region 108a) may have or be defined by an area having a second color (e.g., a beige color), the third indicia 118a (or the third region 110a) may have or be defined by an area having a third color (e.g., a yellow color), and the fourth indicia 120a (or the fourth region 112a) may have or be defined by an area having a fourth color (e.g., a white color). The color of the first indicia 114a (or a first region 106a), the second indicia 116a (or the second region 108a), the third indicia 118a (or the third region 110a), and the fourth indicia 120a (or the fourth region 112a) may be the same or different than one or more of the colors on any portion of the first gauge face 102a and the second gauge face 102b.

In other embodiments, the first indicia 114a (or the first region 106a) may have or be defined by an area having a first pattern, the second indicia 116a (or the second region 108a) may have or be defined by an area having a second pattern, the third indicia 118a (or the third region 110a) may have or be defined by an area having a third pattern, and the fourth indicia 120a (or the fourth region 112a) may have or be defined by an area having a fourth pattern.

The second gauge face 102b may have a first indicia 114b (or a first region 106b), a second indicia 116b (or a second region 108b), a third indicia 118b (or the third region 110b), and a fourth indicia 120b (or the fourth region 112b) that may be identical to counterparts on the first gauge face 102a (i.e., the first indicia 114a (or the first region 106a), the second indicia 116a (or the second region 108a), the third indicia 118a (or the third region 110a), and the fourth indicia 120a (or the fourth region 112a)).

While specific embodiments have been shown and described, it should be understood by those skilled in the art that various changes in form and detail may be made therein.

1. A carbon dioxide regulator assembly for use in carbonating home brewed beer, the carbon dioxide regulator assembly comprising:
an inlet adapted to be coupled to a carbon dioxide source, a first valve adapted to control flow of carbon dioxide from the inlet to a first outlet of the carbon dioxide regulator, the first outlet adapted to be in fluid communication with a first keg in which a first batch of beer to be carbonated is stored;
a first pressure gauge adapted to be in fluid communication with carbon dioxide flowing through the first outlet when the first valve is in an open or partially-open position, the first pressure gauge comprising:
a first gauge face having a first region having a first indicia indicating a carbonation pressure range of a first type of beer at a predefined temperature, a second region having a second indicia indicating a carbonation pressure range of a second type of beer at the predefined temperature, a third region having a third indicia indicating a carbonation pressure range of a third type of beer at the predefined temperature, and a fourth region having a fourth indicia indicating a carbonation pressure range of an over-carbonation condition at the predefined temperature, wherein the first indicia, the second indicia, the third indicia, and the fourth indicia are each non-alpha-numeric; and
a first needle adapted to rotatably displace relative to the first gauge face based on pressure of the carbon dioxide flowing through the first outlet.

2. The carbon dioxide regulator assembly of claim 1, wherein the first indicia includes an area of a first color or combination of colors, the second indicia includes an area of a second color or combination of colors, the third indicia includes an area of a third color or combination of colors, and the fourth indicia includes an area of a fourth color or combination of colors.

3. The carbon dioxide regulator assembly of claim 2, wherein the area of each of the first indicia, the second indicia, the third indicia, and the fourth indicia has an arcuate shape.

4. The carbon dioxide regulator assembly of claim 2, wherein the area of each of the first indicia, the second indicia, the third indicia, and the fourth indicia is defined by a top segment portion extending from a first end to a second end, a bottom segment portion extending from a first end to a second end, a first lateral end portion extending from the first end of the top segment portion to the first end of the bottom segment portion, and a second lateral end portion extending from the second end of the top segment portion to the second end of the bottom segment portion, wherein the top segment portion and the bottom segment portion are each curved.

5. The carbon dioxide regulator assembly of claim 4, wherein the top and bottom segment portions are each circular segments having a same center point, the bottom segment portion having a smaller radius than the top segment portion.

6. The carbon dioxide regulator assembly of claim 5, wherein the center point of the top and bottom segment portions of each of the first indicia, the second indicia, the third indicia, and the fourth indicia are the same.

7. The carbon dioxide regulator assembly of claim 6, wherein the radius of the top segment portions of each of the first indicia, the second indicia, the third indicia, and the fourth indicia are identical, and the radius of the bottom segment portions of each of the first indicia, the second indicia, the third indicia, and the fourth indicia are identical.

8. The carbon dioxide regulator assembly of claim 1, wherein the first indicia includes an area having a first pattern or combination of patterns, the second indicia includes an area having a second pattern or combination of patterns, the third indicia includes an area having a third pattern or combination of patterns, and the fourth indicia includes an area having a fourth pattern or combination of patterns.
